(19) United States
(12) Patent Application Publication
(10) Pub. No.: US 2025/0051213 A1
(43) Pub. Date: Feb. 13, 2025

(54) GLASS PLATE PRODUCTION METHOD

(71) Applicant: AGC Inc., Tokyo (JP)

(72) Inventor: Satoshi OGAMI, Tokyo (JP)

(73) Assignee: AGC Inc., Tokyo (JP)

(21) Appl. No.: 18/931,185

(22) Filed: Oct. 30, 2024

Related U.S. Application Data
(63) Continuation of application No. PCT/JP2023/023047, filed on Jun. 22, 2023.

(30) Foreign Application Priority Data
Jul. 1, 2022 (JP) 2022-106958

(51) Int. Cl. C03B 32/00

(52) U.S. Cl. CPC C03B 32/00

(57) ABSTRACT

A glass plate (a glass plate for cover glasses) with a low concentration of impurities is produced using article cullet. A process of melting glass raw materials and cullet and producing therefrom a glass plate is repeated. The glass plate is further processed into a glass article. The glass article is a cover glass for displays, including the glass plate and a coating provided on a surface of the glass plate. The cullet used includes glass plate cullet that is cullet of the glass plate and article cullet that is cullet of the article cullet. At least one of the mixing ratio of the glass raw material, the mixing ratio of the glass plate cullet, the mixing ratio of the article cullet, the impurity concentration in the glass plate cullet and the impurity concentration in the article cullet is adjusted in accordance with at least one of the impurity concentration in the glass plate cullet and the impurity concentration in the article cullet.

### TECHNICAL FIELD

The present invention relates to a method for producing glass plates.

### BACKGROUND ART

Patent Document 1 discloses that “a glass raw material composition and optionally cullet having the same glass composition as that of a desired molten glass are continuously fed into a melting furnace and melted into a molten glass by heating to about 1600 to 1700° C.” (see paragraph [0025]).

Further, Patent Document 1 discloses that “the molten glass obtained in the above-mentioned melting step is formed into a desired shape in the forming step, and the formed glass is annealed as required in the annealing step; after that, the resulting glass is subjected as required to post-processing such as cutting and polishing by a known method in the post-processing step, thereby obtaining a glass article” (see paragraph [0026]).

### PRIOR ART DOCUMENTS

### Patent Documents

Patent Document 1: WO2018/088503

### DISCLOSURE OF INVENTION

### Technical Problem

As an example of a glass article, there may be mentioned a cover glass for displays in which a coating (an anti-fouling coating, an anti-reflective coating, a print portion etc.) is provided on a surface of a glass plate.

Cullet obtained by crushing such a display cover glass, i.e., cullet of the glass article (article cullet) contains a high level of impurities derived from the coating etc., as compared to cullet of the glass plate (glass plate cullet).

Glass plates to be processed into cover glasses for displays (hereinafter also referred to as “glass plates for cover glasses”) are required to have a high level of quality such as, for example, a lower concentration of impurities than that of conventional soda-lime glass.

For this reason, glass plate cullet is used in the production of glass plates for cover glasses, but not article cullet which is high in impurities.

In recent years, however, studies have been conducted on the use of article cullet in the production of glass plates for cover glasses from the viewpoint of cost reduction and the like.

The present invention has been made under the above-mentioned circumstances. It is an object of the present invention to produce, using article cullet, a glass plate (a glass plate for cover glasses) with a low concentration of impurities.

### SOLUTION TO PROBLEM

As a result of intensive studies, the present inventors have found that the above-mentioned object can be achieved by adoption of the following configurations, and thus have arrived at the present invention.

That is, the present invention provides the following [1] to [15].

[1] A glass plate production method comprising repeating a process of melting glass raw materials and cullet and producing therefrom a glass plate, wherein the glass plate is further processed into a glass article, wherein the glass article is a cover glass for displays, comprising the glass plate and a coating provided on a surface of the glass plate, wherein the cullet includes glass plate cullet that is cullet of the glass plate and article cullet that is cullet of the glass article, and wherein at least one of the mixing ratio of the glass raw materials, the mixing ratio of the glass plate cullet, the mixing ratio of the article cullet, the impurity concentration in the glass raw materials, the impurity concentration in the glass plate cullet and the impurity concentration in the article cullet is adjusted in accordance with at least one of the impurity concentration in the glass plate cullet and the impurity concentration in the article cullet.

[2] The glass plate production method according to [1], wherein the impurity concentration in the article cullet is reduced by performing, on the article cullet, a treatment A of removing a glass-outside attached substance that is a substance attached to the outside of the glass plate.

[3] The glass plate production method according to [2], wherein the glass-outside attached substance in the article cullet contains, as impurities, at least one element selected from the group consisting of Fe, Ti, Co, Ni, Cr, Mo, Mg, Cu and Nb.

[4] The glass plate production method according to any one of [1] to [3], wherein the mixing ratio of the article cullet is 2 mass % or more. [5] The glass plate production method according to any one of [1] to [3], wherein the mixing ratio of the article cullet is 8 mass % or more.

[6] The glass plate production method according to [2] or [3], wherein the glass-outside attached substance in the article current is reduced by 50 mass % or more by performing the treatment A.

[7] The glass plate production method according to any one of [1] to [3], wherein the impurity concentration in the glass plate cullet is reduced by performing, on the glass plate cullet, a treatment A of removing a glass-outside attached substance that is a substance attached to the outside of the glass plate.

[8] The glass plate production method according to [7], wherein the glass-outside attached substance in the glass plate cullet contains Fe as impurities.

[9] The glass plate production method according to any one of [1] to [3], wherein, when the impurity concentration in the glass plate at time n is assumed as Pₙ, the maximum impurity concentration Po in the glass plate as expressed by the following formula (6) is kept less than a predetermined value,

$${P}_{∞} = \frac{{CR}_{B} \times {MR}_{B} \times E 1 + {CR}_{i} \times {MR}_{i} \times E 2 + {CR}_{e} \times {MR}_{e} \times E 3}{( ( E 1 E 2 E 3 ) \hat{} 0.5 - {MR}_{i} \times E 2 - {MR}_{e} \times E 3 )} \qquad ( 6 )$$

where CR_{B} is the impurity concentration in the glass raw materials;
CRᵢ is the overall impurity concentration in the glass plate cullet;
CRₑ is the overall impurity concentration in the article cullet;
MR_{B} is the mixing ratio of the glass raw materials;
MRᵢ is the mixing ratio of the glass plate cullet;
MRₑ is the mixing ratio of the article cullet;
E1 is a numerical value greater than 0 and less than or equal to 1;
E2 is a numerical value greater than 0 and less than or equal to 1;
E3 is a numerical value greater than 0 and less than or equal to 1; and
the impurity concentrations as expressed by CR_{B}, CRᵢ and CRₑ are in units of mass ppm.

[10] The glass plate production method according to [9], wherein, in the formula (6), each of E1, E2 and E3 is in the range of 0.7 to 1.

[11] The glass plate production method according to [9], wherein, in the formula (6),
E1 is given by Eᵢ×Eₑ,
E2 is given by Eₑ×E_{B}, and
E3 is given by Eᵢ×E_{B},
   where E_{B} is the remaining rate of the glass raw materials when melted;
Eᵢ is the remaining rate of the glass plate cullet when melted; and
Eₑ is the remaining rate of the article cullet when melted.

[12] The glass plate production method according to any one of [1] to [3], wherein, when the impurity concentration in the glass plate at time n is assumed as Pₙ, the maximum impurity concentration Po in the glass plate as expressed by the following formula (6) is kept less than a predetermined value,

$${P}_{∞} = \frac{{CR}_{B} \times {MR}_{B} \times E 1 + {CR}_{i} \times {MR}_{i} \times E 2 + {CR}_{e} \times {MR}_{e} \times E 3}{( ( E 1 E 2 E 3 ) \hat{} 0.5 - {MR}_{i} \times E 2 - {MR}_{e} \times E 3 )} \qquad ( 6 )$$

where CR_{B} is the impurity concentration in the glass raw materials;
CRᵢ is the impurity concentration in a glass-outside attached substance attached to the outside of the glass plate in the glass plate cullet;
CRₑ is the impurity concentration in a glass-outside attached substance attached to the outside of the glass plate in the article cullet;
MR_{B} is the mixing ratio of the glass raw materials;
MRᵢ is the mixing ratio of the glass plate cullet;
MRₑ is the mixing ratio of the article cullet;
E1 is given by Eᵢ×Eₑ;
E2 is given by Eₑ×E_{B};
E3 is given by Eᵢ×E_{B};
E_{B} is the remaining rate of the glass raw materials when melted;
Eᵢ is the remaining rate of the glass plate cullet when melted;
Eₑ is the remaining rate of the article cullet when melted; and
the impurity concentrations as expressed by CR_{B}, CRᵢ and CRₑ are in units of mass ppm.

[13] The glass plate production method according to [12], wherein, in the formula (6), each of E1, E2 and E3 is in the range of 0.7 to 1.

[14] The glass plate production method according to any one of [1] to [3], wherein the coating comprises at least one selected from the group consisting of an anti-fouling coating, an anti-reflective coating and a print portion.

[15] The glass plate production method according to any one of [1] to [3], wherein the glass plate is a chemically strengthened glass plate.

### ADVANTAGEOUS EFFECTS OF INVENTION

According to the present invention, a glass plate (a glass plate for cover glasses) with a low concentration of impurities can be produced using glass article cullet.

### BRIEF DESCRIPTION OF DRAWINGS

FIG. 1 is a chart diagram illustrating a process flow for production of a glass plate and for production of a glass article (a cover glass for displays).

### DESCRIPTION OF EMBODIMENTS

Hereinafter, preferred embodiments of the present invention will be described below.

It is however to be understood that the present invention is not limited to the following embodiments. Various modifications and replacements can be made to the following embodiments without departing from the scope of the present invention.

The compositions of various components are determined by using known measurement methods. More specifically, for example, measurement methods such as X-ray fluorescence (XRF) analysis method and ICP (inductively coupled plasma) optical emission spectroscopy are used alone or in combination thereof.

### [Glass Plate Production Method]

The glass plate production method according to the present invention (hereinafter also referred to as the “present production method”) is carried out by repeating a process of melting glass raw materials and cullet and producing therefrom a glass plate.

### <Glass Raw Materials>

The glass raw materials include a silicon source, an aluminum source, an alkali metal source and an alkaline earth metal source.

The silicon source is a compound that becomes or forms SiO₂ by melting. As an example of the silicon source, silica sand may be mentioned.

The aluminum source is a compound that becomes or forms Al₂O₃ by melting. As an example of the aluminum source, aluminum oxide may be mentioned.

The alkali metal source is a compound that becomes or forms LiO₂, NaO₂ or K₂O by melting. As examples of the alkali metal source, there may be mentioned carbonates, sulfates, nitrates, oxides, hydroxides, chlorides and fluorides of alkali metals.

The alkaline earth metal source is a compound that becomes or forms MgO, CaO, SrO or BaO by melting. As examples of the alkaline earth metal source, there may be mentioned carbonates, sulfates, nitrates, oxides, hydroxides, chlorides and fluorides of alkaline earth metals. Composite carbonates such as dolomite and composite oxides such as calcined dolomite are also usable.

As the other glass raw materials, tin oxide, titanium oxide, zirconium oxide, zircon, cerium oxide, antimony oxide, iron oxide, cobalt oxide, chromium oxide, copper oxide, nickel oxide, yttrium oxide and the like may be mentioned.

Each of the glass raw materials can be of a single kind or can be of two or more kinds in combination.

The particle size of the respective glass raw materials is not particularly limited and is selected as appropriate.

### <Cullet>

Cullet is waste glass discharged from the process of glass production or the like.

In the present production method, glass plate cullet, i.e., cullet of glass plates and article cullet, i.e., cullet of glass articles (cover glasses for displays) are used as the cullet as will be explained later.

### <Melting and Formation>

The method of melting the glass raw materials and the cullet is not particularly limited. Although a conventionally known method can be adopted, preferred is a method in which the glass raw materials and the cullet are fed into and melted in a melting furnace.

The type of the melting furnace is not particularly limited. The melting furnace can be of a batch type or of a continuous type.

For example, the glass raw materials and the cullet are continuously fed into the melting furnace in accordance with a desired glass composition and melted into a molten glass by heating to a temperature of about 1600 to 1700° C.

The obtained molten glass is formed into a desired shape, followed by performing annealing as required and, optionally, performing post-processing such as cutting or polishing by a known method.

For example, the molten glass is formed into a plate shape by a known method such as a float method, a down-draw method or a fusion method, and then, the formed glass annealed as required, thereby obtaining a glass plate.

### <Glass Plate>

The glass plate is a glass plate for cover glasses.

The thickness of the glass plate is, for example, at least 0.1 mm and at most 5mm.

The dimensions of the glass plate are selected as appropriate depending on the intended use of the glass plate.

The glass plate obtained by forming the molten glass has basically the same glass composition as that of the molten glass, and preferably has the glass composition capable of being strengthened by chemically strengthening treatment.

### «Chemical Strengthening Treatment»

The glass plate is preferably chemically strengthened.

As the method of chemical strengthening treatment, a conventionally known method can be adopted. For example, an ion exchange treatment is performed on a main surface of the glass plate to form a surface layer with residual compressive stress. More specifically, alkali metal ions of small ionic radius (such as Li ions and/or Na ions) near the main surface of the glass plate are exchanged with alkali metal ions of larger ionic radius (such as Na ions and/or K ions) at a temperature lower than or equal to the glass transition point. By this treatment, compressive stress remains in the main surface of the glass plate whereby the glass plate is improved in strength.

The surface compressive stress (CS) and the depth of surface compressive stress layer (DOL) of the chemically strengthened glass plate are adjusted as appropriate. The CS is preferably 300 MPa or more. The DOL is preferably 10 μm or more.

### <Glass Article: Cover Glass for Displays>

The glass plate is further processed into a glass article.

The glass article is a cover glass for displays, including the glass plate and a coating provided on a surface of the glass plate.

The cover glass for displays is a member that protects the display area in various displays such as liquid crystal display (LCD), organic EL display (OLED) and the like.

### «Coating»

As the coating, at least one selected from the group consisting of an anti-fouling coating, an anti-reflective coating and a print portion may be mentioned.

### (Anti-fouling Coating)

The anti-fouling coating makes it easier to remove smudge (such as human fingerprints).

As the method of forming the anti-fouling coating, usable are both of a dry method such as a vacuum deposition method, an ion beam assisted deposition method, an ion plating method, a sputtering method or a plasma CVD method and a wet method such as a spin coating method, a dip coating method, a casting method, a slit coating method or a spraying method.

The material constituting the anti-fouling coating can be appropriately selected from materials capable of imparting anti-fouling properties, water repellency and oil repellency.

More specifically, a fluorine-containing organic silicon compound may be mentioned.

Suitable examples of the fluorine-containing organic silicon compound are organic silicon compounds each having at least one group selected from the group consisting of a polyfluoropolyether group, a polyfluoroalkylene group and a polyfluoroalkyl group. The polyfluoropolyether group refers to a monovalent or divalent group having a structure in which a polyfluoroalkylene group and a polyfluoroalkylene group are bonded via an ethylenic oxygen atom. The polyfluoroalkylene group and the polyfluoroalkyl group may be a perfluoroalkylene group and a perfluoroalkyl group, respectively.

The thickness of the anti-fouling coating is preferably 2 nm or more, more preferably 4 nm or more. On the other hand, the thickness of the anti-fouling coating is preferably 20 nm or less, more preferably 15 nm or less, still more preferably 10 nm or less.

### (Anti-reflective Coating)

The anti-reflective coating is a coating that suppresses reflection of light and, for example, has a laminated structure of high and low refractive index layers.

The high refractive index layer is a layer having, for example, a refractive index of 1.9 or higher at a wavelength of 550 nm. The low refractive index layer is a layer having, for example, a refractive index of 1.6 or lower at a wavelength of 550 nm.

The anti-reflective coating may be provided with one high refractive index layer and one low refractive index layer or may be provided with two or more high refractive index layers and two or more low refractive index layers. In the case where the anti-reflective coating is provided with two or more high refractive index layers and two or more low refractive index layers, it is preferable that the high refractive index layers and the low refractive index layers are alternately laminated together.

The materials constituting the high and low refractive index layers are selected in view of the degree of anti-reflection required, productivity and the like.

As the material constituting the high refractive index layer, for example, a material containing Nb, Ti, Zr, Ta, Si or the other element may be mentioned. Specific examples of such a material are niobium oxide (Nb₂O₅), titanium oxide (TiO₂), zirconium oxide (ZrO₂), tantalum oxide (Ta₂O₅), silicon nitride, and the like.

As the material constituting the low refractive index layer, for example, a material containing Si may be mentioned. Specific examples of such a material are silicon oxide (SiO₂), a mixed oxide of Si and Sn, a mixed oxide of Si and Zr, a mixed oxide of Si and Al, and the like.

As the method of forming the anti-reflective coating (high and low refractive index layers), a conventionally know method using, e.g., magnetron sputtering, pulse sputtering, AC sputtering, digital sputtering or the like may be mentioned. For example, the glass plate is placed in a chamber filled with a mixed gas atmosphere of inert gas and oxygen gas, and then, each of the layers is formed on the glass plate by using a target containing a desired element.

The thickness of the anti-reflective coating is, for example, 100 to 300 nm.

### (Print Portion)

The print portion is provided in a frame shape on the surface of the glass plate, and shields wirings of the display device or the like.

The print portion is formed by printing a color ink on the glass plate.

As the printing method, for example, a bar coating method, a reverse coating method, a gravure coating method, a die coating method, a roll coating method, a screen printing method and the like may be mentioned.

As the color ink, for example, an organic ink containing a colorant such as a die or a pigment and an organic resin may be mentioned. Although the color ink is often black or white in color, the color of the color ink is not particularly limited.

The dye or pigment can be used without particular limitation.

Examples of the organic resin are: homopolymers such as epoxy resin, acrylic resin, polyethylene terephthalate, polyethersulfone, polyarylate, polycarbonate, transparent ABS resin, phenolic resin, acrylonitrile-butadiene-styrene resin, polyurethane, polymethyl methacrylate, polyvinyl resin, polyvinyl butyral, polyether ether ketone, polyethylene, polyester, polypropylene, polyamide, polyimide and the like; and copolymers of monomers of these resins and monomers copolymerizable therewith.

The thickness of the print portion is preferably 2 μm or more, more preferably 4 μm or more. On the other hand, the thickness of the print portion is preferably 20 μm or less, more preferably 15 μm or less, still more preferably 10 um or less.

### <Impurities and Recycling Concentration>

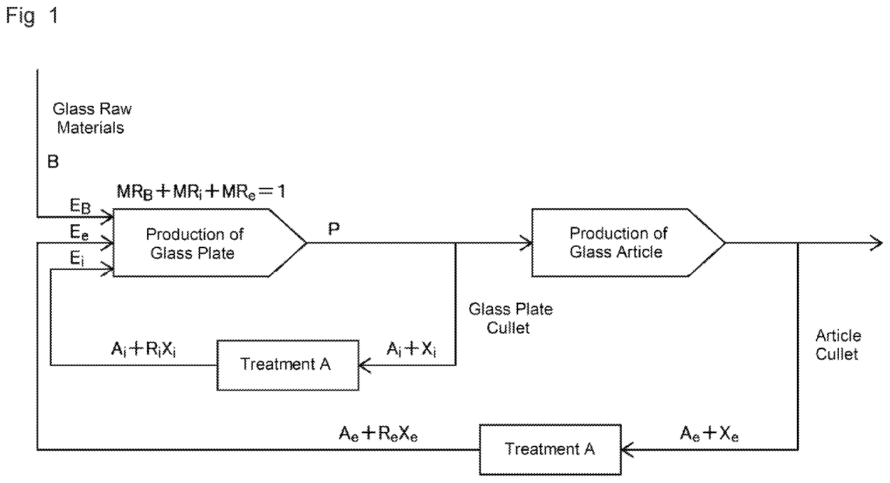

The present production method will be described in detail below with reference to FIG. 1.

FIG. 1 is a chart diagram illustrating a process flow for production of a glass plate and for production of a glass article (a cover glass for displays).

In the present production method, glass plate cullet (cullet of the glass plate) and article cullet (cullet of the glass article) are used in addition to the glass raw materials as mentioned above.

As shown in FIG. 1, in the case where the production of a glass plate and the production of a glass article are repeated, a part of the produced glass articles is incorporated as the article cullet in the next cycle of glass plate production.

Herein, an attached substance attached to the outside of the glass plate is referred to as a “glass-outside attached substance”.

The glass-outside attached substance contains an element that can be impurities to the glass plate.

For example, the glass plate is conveyed for use in the production of the glass article, and iron particles may be attached to the outside of the glass plate during the conveyance. These iron particles are a “glass-outside attached substance”.

The iron particles as the glass-outside attached substance contain iron (Fe).

In other words, the glass-outside attached substance in the glass plate cullet contains Fe as impurities.

Further, the coating (anti-fouling coating, anti-reflective coating, print portion etc.) on the outside of the glass plate in the glass article is also a “glass-outside attached substance”.

The coating (print portion) as the glass-outside attached substance contains, for example, titanium (Ti), cobalt (Co), nickel (Ni) or the like.

The coating (anti-reflective coating) as the glass-outside attached substance contains, for example, niobium (Nb).

Furthermore, the coating as the glass-outside attached substance may contain chromium (Cr), molybdenum (Mo), magnesium (Mg) and copper (Cu).

Thus, the glass-outside attached substance in the article cullet contains any of Ti, Co, Ni, Cr, Mo, Mg, Cu and Nb in addition to Fe.

In other words, the glass-outside attached substance in the article cullet contains as impurities at least one kind of element selected from the group (hereinafter also referred to as “group G”) consisting of Fe, Ti, Co, Ni, Cr, Mo, Mg, Cu and Nb. The glass-outside attached substance in the article cullet may contain two or more kinds of elements selected from the group G.

For example, the coating as the glass-outside attached substance is removed by, during a process of processing the glass article into article cullet, performing a treatment of e.g. scraping the surface of the glass article or the like (hereinafter referred to as “treatment A”). In other words, the treatment A is a treatment for removing the glass-outside attached substance as will be described in more detail later.

The treatment A is also performed during a process of processing the glass plate into glass plate cullet, thereby removing the iron particles as the glass-outside attached substance.

However, the glass-outside attached substance in the cullet (glass plate cullet and article cullet) may not be completely removed for reasons such as insufficient treatment A.

In such a case, impurities in the glass-outside attached substance (hereinafter referred to as “glass-outside impurities”) in the cullet are melted together with the glass portion of the cullet and incorporated in the inside of the glass plate produced in the subsequent production cycle.

Impurities incorporated in the inside of the glass plate are referred to as “glass-inside impurities”.

Differently from the glass-outside impurities, the glass-inside impurities are not basically removed even by performing the treatment A.

While the production of a glass plate and the production of a glass article are repeated, the concentration of glass-inside impurities in the glass plate produced gradually increases. This is called “recycling concentration” for convenience.

The influence of recycling concentration is particularly pronounced when the article cullet high in impurities is used.

Therefore, in the present production method, at least any one of the mixing ratio of the glass raw materials, the mixing ratio of the glass plate cullet, the mixing ratio of the article cullet, the impurity concentration in the glass raw materials, the impurity concentration in the glass plate cullet and the impurity concentration in the article cullet is adjusted in accordance with at least one of the impurity concentration in the glass plate cullet and the impurity concentration in the article cullet (preferably, the impurity concentration in the article cullet).

This enables production of the glass plate (glass plate for cover glasses) with a low concentration of impurities (glass-inside impurities) even when the cullet (in particular, article cullet) high in impurities (glass-outside impurities) is used.

For example, when the concentration of impurities (glass-inside impurities) in the glass plate to be produced is higher than a predetermined value, the treatment A is performed on the article cullet to be used so that the concentration of impurities in the article cullet to be used is reduced.

The concentration of impurities in the glass plate cullet to be used may be reduced by performing the treatment A on the glass plate cullet to be used. <P_{∞}>

The present production method will be now described in more detail below.

Here, from the concentration Pₙ of impurities (glass-inside impurities) in the glass plate at time n, the maximum concentration P_{∞}of impurities (glass-inside impurities) in the glass plate (concentration Pₙ at n=∞) is calculated.

The concentration Pₙ₊₁ of impurities (glass-inside impurities) in the glass plate at time n+1 is expressed by the following formula (1).

$${P}_{n + 1} = \frac{B \cdot {MR}_{B}}{{E}_{B}} + \frac{( {A}_{i} + {R}_{i} \cdot {X}_{i} ) \cdot {MR}_{i}}{{E}_{i}} + \frac{( {A}_{e} + {R}_{e} \cdot {X}_{e} ) \cdot {MR}_{e}}{{E}_{e}} \qquad ( 1 )$$

The meanings of the first to third terms on the right side of the formula (1) are as follows.

First term: The amount of impurities in the glass raw materials.

Second term: The amount of impurities in the glass plate cullet.

Third term: The amount of impurities in the article cullet.

In the formula (1), the definitions of the respective parameters are as follows.

See also FIG. 1.

P: The concentration [mass ppm] of impurities (glass-inside impurities) in the glass plate.

B: The concentration [mass ppm] of impurities in the glass raw materials.

Aᵢ: The concentration [mass ppm] of glass-inside impurities in glass plate cullet.

Aₑ: The concentration [mass ppm] of glass-inside impurities in the article cullet.

Xᵢ: The concentration [mass ppm] of impurities in the glass-outside attached substance when the glass plate cullet is in the form of the glass plate.

Xₑ: The concentration [mass ppm] of impurities in the glass-outside attached substance when the article cullet is in the form of the glass article.

Rᵢ: The remaining rate of the glass-outside attached substance in the glass plate cullet.

Rₑ: The remaining rate of the glass-outside attached substance in the article cullet.

When the glass plate is used as it is as the glass plate cullet, Rᵢ is 1 (100 mass %). When 30% of the glass-outside attached substance is removed by the treatment A, Rᵢ is 0.7 (70 mass %).

Likewise, when the glass article is used as it is as the article cullet, Rₑ is 1 (100 mass %). When 30 mass % of the glass-outside attached substance is removed by the treatment A, Rₑ is 0.7 (70 mass %).

MR_{B}: The mixing ratio of the glass raw materials.

MRᵢ: The mixing ratio of the glass plate cullet.

MRₑ: The mixing ratio of the article cullet.

The sum of MR_{B}, MRᵢ and MRₑ is 1 (MR_{B}+MRᵢ+MRₑ=1).

E_{B}: The remaining rate of the glass raw materials when melted.

Eᵢ: The remaining rate of the glass plate cullet when melted.

Eₑ: The remaining rate of the article cullet when melted. For example, when a given sample is evaporated in an amount of 10 mass % during melting, the remaining rate (remaining rate when melted) of the sample is 0.9.

Rᵢ×Xᵢ means the concentration of glass-outside impurities in the glass plate cullet.

Aᵢ+Rᵢ×Xᵢ means the concentration of impurities (glass-inside impurities+glass-outside impurities) in the glass plate cullet.

Rₑ×Xₑ means the concentration of glass-outside impurities in the article cullet.

Aₑ+Rₑ×Xₑ means the concentration of impurities (glass-inside impurities+glass-outside impurities) in the article cullet.

In view of the fact that the concentration Aᵢ of glass-inside impurities in the glass plate cullet and the concentration Ae of glass-inside impurities in the article cullet are both equal to the concentration Pₙ of glass-inside impurities in the glass plate at time n, the formula (1) is transformed into the following formula (2).

$${P}_{n + 1} = \frac{B \cdot {MR}_{B}}{{E}_{B}} + \frac{( {P}_{n} + {R}_{i} \cdot {X}_{i} ) \cdot {MR}_{i}}{{E}_{i}} + \frac{( {P}_{n} + {R}_{e} \cdot {X}_{e} ) \cdot {MR}_{e}}{{E}_{e}} \qquad ( 2 )$$

By transformation of the formula (2), the following recurrence formula (3) is obtained.

$${P}_{n + 1} = {P}_{n} ( \frac{{MR}_{Ai}}{{E}_{i}} + \frac{{MR}_{e}}{{E}_{e}} ) + \frac{B \cdot {MR}_{B}}{{E}_{B}} + \frac{{R}_{i} \cdot {X}_{i} \cdot {MR}_{i}}{{E}_{i}} + \frac{{R}_{e} \cdot {X}_{e} \cdot {MR}_{e}}{{E}_{e}} \qquad ( 3 )$$

Then, the solution for the recurrence formula (3) is expressed by the following formula (4).

$${P}_{n} = {( \frac{{MR}_{i} {E}_{e} + {E}_{i} {MR}_{i}}{{E}_{i} {E}_{e}} )}^{n - 1} \cdot ( {P}_{1} - \frac{{BMR}_{B} {E}_{i} {E}_{e} + {R}_{i} {X}_{i} {MR}_{i} {E}_{B} {E}_{e} + {R}_{e} {X}_{e} {MR}_{e} {E}_{B} {E}_{i}}{{E}_{B} ( {E}_{i} {E}_{e} - {MR}_{i} {E}_{e} - {E}_{i} {MR}_{e} )} ) + \frac{{BMR}_{B} {E}_{i} {E}_{c} + {R}_{i} {X}_{i} {MR}_{i} {E}_{B} {E}_{e} + {R}_{e} {X}_{e} {MR}_{e} {E}_{B} {E}_{i}}{{E}_{B} ( {E}_{i} {E}_{e} - {MR}_{i} {E}_{e} - {E}_{i} {MR}_{e} )} \qquad ( 4 )$$

From the formula (4), the maximum concentration P_{∞} of glass-inside impurities in the glass plate is expressed by the following formula (5).

$${P}_{∞} = \frac{{BMR}_{B} {E}_{i} {E}_{e} + {R}_{i} {X}_{i} {MR}_{i} {E}_{B} {E}_{e} + {R}_{e} {X}_{e} {MR}_{e} {E}_{B} {E}_{i}}{{E}_{B} ( {E}_{i} {E}_{e} - {MR}_{i} {E}_{e} - {E}_{i} {MR}_{e} )} \qquad ( 5 )$$

Since only the glass raw materials are used in the initial cycle of production, MR_{B}=1, and thus, the initial concentration can be expressed as P₁=B/E_{B}.

Further, the formula (5) is rearranged.

Assuming Eᵢ×Eₑ=E1, Eₑ×E_{B}=E2 and Eᵢ×E_{B}=E3, the numerator on the right side of the formula (5) is expressed as (B×MR_{B}×E1)+(_{R}i×Xᵢ×MRᵢ×E2)+(Re×Xₑ ×MRₑ×E3)=(CR_{B}×MR_{B}×E1)+(CRᵢ×MRᵢ×E2)+(CRₑ×MRₑ×E3) (B=CR_{B}, Rᵢ×Xᵢ=CRᵢ, Rₑ×Xₑ=CRₑ).

The denominator on the right side of the formula (5) is then expressed as (E_{B}×Eᵢ×Eₑ)−(E_{B}×MRᵢ×Eₑ)−(E_{B}×Eᵢ×MRₑ)−(E_{B}×Eᵢ×Eₑ)−(MRᵢ×E2)−(E3×MRₑ)=(E1E2E3) \hat{ } 0.5−(MRᵢ×E2)−(E3×MRₑ).

In other words, the following formula (6) is derived by rearrangement of the formula (5).

$${P}_{∞} = \frac{{CR}_{B} \times {MR}_{B} \times E 1 + {CR}_{i} \times {MR}_{i} \times E 2 + {CR}_{e} \times {MR}_{e} \times E 3}{( ( E 1 E 2 E 3 ) \hat{} 0.5 - {MR}_{i} \times E 2 - {MR}_{e} \times E 3 )} \qquad ( 6 )$$

In the formula (6),

CR_{B} (=B) is the concentration [mass ppm] of impurities in the raw glass materials;

CRᵢ (=Rᵢ×Xᵢ) is the concentration [mass ppm] of glass-outside impurities (impurities in the glass-outside attached substance) in the glass plate cullet;

CRₑ (=Rₑ×Xₑ) is the concentration [mass ppm] of glass-outside impurities (impurities in the glass-outside attached substance) in the article cullet;

MR_{B} is the mixing ratio of the glass raw materials;

MRᵢ is the mixing ratio of the glass plate cullet;

MRₑ is the mixing ratio of article cullet;

E1 is given by Eᵢ×Eₑ;

E2 is given by Eₑ×E_{B};

E3 is given by Eᵢ×E_{B};

E_{B} is the remaining rate of the glass raw materials when melted;

Eᵢ is the remaining rate of the glass plate cullet when melted; and

Eₑ is the remaining rate of the article cullet when melted.

Each of E1, E2 and E3 is a numerical value greater than 0 and less than or equal to 1, preferably a numerical value within the range of 0.7 to 1.

The respective parameters are adjusted in such a manner that the value of P_{∞} is kept less than a predetermined value.

For example, consideration will be given to the case where the concentration P_{∞} of certain impurities is kept less than 360 mass ppm.

In Ex. 1 and 2 shown in Table 1, Re (the remaining rate of the glass-outside attached substance in the article cullet) is set to different values.

TABLE 1

| | | | | | | | | | | | | | | | Long-term |
|---|---|---|---|---|---|---|---|---|---|---|---|---|---|---|---|
| | B | | | | | | | | | Xᵢ | Xₑ | P₁ | P₂ | P_{∞} | management |
| | mass | E_{B} | Eᵢ | Eₑ | Rᵢ | Rₑ | MR_{B} | MRᵢ | MRₑ | mass | mass | mass | mass | mass | (less than 360 |
| | ppm | — | — | — | — | — | — | — | — | ppm | ppm | ppm | ppm | ppm | mass ppm) |
| Ex. 1 | 300 | 0.89 | 1 | 1 | 1 | 0.02 | 0.6 | 0.3 | 0.1 | 0 | 8600 | 337.1 | 354.3 | 365.7 | x |
| Ex. 2 | 300 | 0.89 | 1 | 1 | 1 | 0.01 | 0.6 | 0.3 | 0.1 | 0 | 8600 | 337.1 | 345.7 | 351.4 | ∘ |

As shown in Table 1, in Ex. 1 in which Re is 0.02 (2 mass %), the concentration P1in the initial cycle of production and the concentration P₂ in the second cycle of production are less than 360 mass ppm; but the maximum concentration P_{∞} is 365.7 mass ppm and is not kept less than 360 mass ppm.

In this way, the common glass plate production method (Ex. 1) can result in an unfavorable outcome under the influence of recycling concentration. (In the column “Long-term management” of Table 1, the symbol “×” is indicated meaning that P_{∞} cannot be kept less than 360 mass ppm.)

Hence, in Ex. 2, Re is reduced to 0.01 (1 mass %) by varying the conditions of the after-mentioned treatment A on the article cullet to be used and thereby removing the glass-outside attached substance by an amount more than that in Ex. 1. In this case, P_{∞} is 351.4 mass ppm, and the values of not only the concentration P₁ in the initial cycle of production and the concentration P2 in the second cycle of production but also the maximum concentration Po are kept less than 360 mass ppm. (In the column “Long-term management” of Table 1, the symbol “ο” is indicated meaning that P_{∞} is kept less than 360 mass ppm.)

As described above, the influence of recycling concentration can be suppressed over a long period of time by calculating the maximum impurity concentration P_{∞} of the glass plate and adjusting various parameters in such a manner that the calculated value of Po is kept less than a predetermined value.

In the above-mentioned example shown in Table 1, the impurity concentration (Aₑ+Rₑ×Xₑ) in the article cullet is adjusted by varying the remaining rate of the glass-outside attached substance in the article cullet as the parameter. The parameter to be varied is not limited to this.

As the parameter to be varied, for example, the mixing ratio (MR_{B}) of the glass raw materials, the mixing ratio (MRᵢ) of the glass plate cullet, the mixing ratio (MRₑ) of the article cullet, the impurity concentration (B) in the glass raw materials, the impurity concentration (Aᵢ+Rᵢ×Xᵢ) in the glass plate cullet and the impurity concentration (Ae +Rₑ×Xₑ) in the article cullet may be mentioned.

The above-mentioned example of Table 1 show that the glass-outside attached substance in the article cullet is reduced by 50 mass % by performing the treatment A on the article cullet.

The rate of reduction of the glass-outside attached substance by the treatment A is preferably 30 mass % or more, more preferably 40 mass % or more, still more preferably 50 mass % or more.

From the viewpoint of cost reduction etc., a higher MRₑ (mixing ratio of the article cullet) is preferred. More specifically, MRₑ is preferably 0.02 (2 mass %) or higher, more preferably 0.08 (8 mass %) or higher. MRₑ in Ex. 1 and 2 is set to 0.1 (10 mass %) and thus is preferable.

For calculation of P_{∞} expressed by the formula (6), the actual measurement of CRᵢ and CRₑ is relatively difficult.

Therefore, Aᵢ+Rᵢ×Xᵢ may be used as CRᵢ in place of Rᵢ×Xᵢ. Likewise, Aₑ+Rₑ×Xₑ may be used as CRₑ in place of Rₑ×Xₑ.

In this case, CRᵢ means the overall impurity concentration in the glass plate cullet; and CRₑ means the overall impurity concentration in the article cullet.

Such replacement leads to an increased value of P_{∞}. It is safer to control the increased value of P_{∞} to be less than a predetermined value.

E_{B}, Eᵢ and Eₑ (and, by extension, their products E1, E2 and E3) may be measured values, or may be treated as the parameters.

In either case, each of E1, E2 and E3 is a numerical value greater than 0 and less than or equal to 1, preferably a numerical value within the range of 0.7 to 1, as mentioned above.

### <Treatment A>

As an example of the treatment A, there may be mentioned a treatment by which surface removal and particle size control of a sample are simultaneously conducted.

More specifically, for example, a commercially available crushing machine (product name: Microsizer, manufactured by Donico Inter Co., Ltd.) is suitably used for such a treatment.

In the Microsizer, a plurality of rotors rotate to cause a sample fed in the machine to rub against each other by the force of the rotors and the wind power of the rotors. Due to the principle of air sorting, only the sample particles smaller than or equal to predetermined size are migrated toward the upper side. By this, the surface removal and the particle size control of the sample are simultaneously conducted.

As other examples of the treatment A, a sandblasting treatment and an acid treatment may be mentioned.

In the sandblasting treatment, an abrasive media (abrasive material) such as steel particles, sand or the like is blasted against a surface of a sample by means of compressed air. By such a treatment, at least a part of the sample surface is removed.

In the acid treatment, more specifically, a sample is etched using an aqueous solution containing an acid as an etching solution. By this treatment, a surface of the sample is dissolved. In other words, at least a part of the sample surface is removed. Examples of the acid contained in the etching solution are hydrogen fluoride (HF), sulfuric acid, nitric acid, hydrochloric acid, hexafluorosilicic acid and the like. Preferred is hydrogen fluoride.

The method of etching is not particularly limited. Preferred is, for example, a method of etching by immersion of the sample in the etching solution.

The etching conditions such as the acid content of the etching solution, the temperature of the etching solution, the time of immersion in the etching solution (etching time) and the like are set as appropriate.

For example, in the case where the glass-outside attached substance is iron particles (iron particles adhered to the outside of the glass plate during the conveyance of the glass plate), the treatment A may be a treatment of removing such iron particles with the use of a known magnetic separator or metal detector.

The treatment A, when regarded as a treatment for reducing the amount of the glass-outside attached substance, is not limited to the above-mentioned treatment.

For example, the treatment A can be a treatment of reducing Rₑ by mixing article cullet a of high Rₑ (remaining rate of the glass-outside attached substance) with article cullet b of low Rₑ (provided that Aₑ and Xₑ of the article cullet b are the same as those of the article cullet a). Although the treatment A is indicated in two places in FIG. 1, it is acceptable to employ different treatments in these two places as the treatment A.

This application is a continuation of PCT Application No. PCT/JP2023/023047, filed on Jun. 22, 2023, which is based upon and claims the benefit of priority from Japanese Patent Application No. 2022-106958 filed on Jul. 1, 2022. The contents of those applications are incorporated herein by reference in their entireties.

What is claimed is:

1. A glass plate production method comprising repeating a process of melting glass raw materials and cullet and producing therefrom a glass plate,
wherein the glass plate is further processed into a glass article,
wherein the glass article is a cover glass for displays, comprising the glass plate and a coating provided on a surface of the glass plate,
wherein the cullet includes glass plate cullet that is cullet of the glass plate and article cullet that is cullet of the article cullet, and
wherein at least one of the mixing ratio of the glass raw materials, the mixing ratio of the glass plate cullet, the mixing ratio of the article cullet, the impurity concentration in the glass plate cullet and the impurity concentration in the article cullet is adjusted in accordance with at least one of the impurity concentration in the glass plate cullet and the impurity concentration in the article cullet.

2. The glass plate production method according to claim 1, wherein the impurity concentration in the article cullet is reduced by performing, on the article cullet, a treatment A of removing a glass-outside attached substance that is a substance attached to the outside of the glass plate.

3. The glass plate production method according to claim 2, wherein the glass-outside attached substance in the article cullet contains, as impurities, at least one selected from the group consisting of Fe, Ti, Co, Ni, Cr, Mo, Mg, Cu and Nb.

4. The glass plate production method according to claim 1, wherein the mixing ratio of the article cullet is 2 mass % or more.

5. The glass plate production method according to claim 1, wherein the mixing ratio of the article cullet is 8 mass % or more.

6. The glass plate production method according to claim 2, wherein the glass-outside attached substance in the article cullet is reduced by 50 mass % or more by performing the treatment A.

7. The glass plate production method according to claim 1, wherein the impurity concentration in the glass plate cullet is reduced by performing, on the glass plate cullet, a treatment A of removing a glass-outside attached substance that is a substance attached to the outside of the glass plate.

8. The glass plate production method according to claim 7, wherein the glass-outside attached substance in the glass plate cullet contains Fe as impurities.

9. The glass plate production method according to claim 1, wherein, when the impurity concentration in the glass plate at time n is assumed as Pₙ, the maximum impurity concentration P_{∞} in the glass plate as expressed by the following formula (6) is kept less than a predetermined value,
$${P}_{∞} = \frac{{CR}_{B} \times {MR}_{B} \times E 1 + {CR}_{i} \times {MR}_{i} \times E 2 + {CR}_{e} \times {MR}_{e} \times E 3}{( ( E 1 E 2 E 3 ) \hat{} 0.5 - {MR}_{i} \times E 2 - {MR}_{e} \times E 3 )} \qquad ( 6 )$$
where CR_{B} is the impurity concentration in the glass raw materials;
CRᵢ is the overall impurity concentration in the glass plate cullet;
CRₑ is the overall impurity concentration in the article cullet;
MR_{B} is the mixing ratio of the glass raw materials;
MRᵢ is the mixing ratio of the glass plate cullet;
MRₑ is the mixing ratio of the article cullet;
E1 is a numerical value greater than 0 and less than or equal to 1;
E2 is a numerical value greater than 0 and less than or equal to 1;
E3 is a numerical value greater than 0 and less than or equal to 1; and
the impurity concentrations as expressed by CR_{B}, CRᵢ and CRₑ are in units of mass ppm.

10. The glass plate production method according to claim 9, wherein, in the formula (6), each of E1, E2 and E3 is in the range of 0.7 to 1.

11. The glass plate production method according to claim 9, wherein, in the formula (6),
E1 is given by Eⁱ×E^{e},
E2 is given by E^{e}×E^{B}, and
E3 is given by Eⁱ×E^{B}
where E_{B} is the remaining rate of the glass raw materials when melted,
Eᵢ is the remaining rate of the glass plate cullet when melted, and
Eₑ is the remaining rate of the article cullet when melted.

12. The glass plate production method according to claim 1, wherein, when the impurity concentration in the glass plate at time n is assumed as Pₙ, the maximum impurity concentration P_{∞} in the glass plate as expressed by the following formula (6) is kept less than a predetermined value,
$${P}_{∞} = \frac{{CR}_{B} \times {MR}_{B} \times E 1 + {CR}_{i} \times {MR}_{i} \times E 2 + {CR}_{e} \times {MR}_{e} \times E 3}{( ( E 1 E 2 E 3 ) \hat{} 0.5 - {MR}_{i} \times E 2 - {MR}_{e} \times E 3 )} \qquad ( 6 )$$
where CR_{B} is the impurity concentration in the glass raw materials;
CRᵢ is the impurity concentration in a glass-outside attached substance attached to the outside of the glass plate in the glass plate cullet;
CRₑ is the impurity concentration in a glass-outside attached substance attached to the outside of the glass plate in the article cullet;
MR_{B} is the mixing ratio of the glass raw materials;
MRᵢ is the mixing ratio of the glass plate cullet;
MRₑ is the mixing ratio of the article cullet;
E1 is given by Eᵢ×Eₑ;
E2 is given by Eₑ×E_{B};
E3 is given by Eᵢ×E_{B};
E_{B} is the remaining rate of the glass raw materials when melted;
Eᵢ is the remaining rate of the glass plate cullet when melted;
Eₑ is the remaining rate of the article cullet when melted; and
the impurity concentrations as expressed by CR_{B}, CRᵢ and CRₑ are in units of mass ppm.

13. The glass plate production method according to claim 12, wherein, in the formula (6), each of E1, E2 and E3 is in the range of 0.7 to 1.

14. The glass plate production method according to claim 1, wherein the coating comprises at least one selected from the group consisting of an anti-fouling coating, an anti-reflective coating and a print portion.

15. The glass plate production method according to claim 1, wherein the glass plate is a chemically strengthened glass plate.
